(19) United States
(12) Patent Application Publication
(10) Pub. No.: US 2006/0108081 A1
(43) Pub. Date: May 25, 2006

(54) Adhesive composition based on polymers and saccharides for the finishing process of a fibrous web

(76) Inventors: Ludivine Onic, Reims (FR); Chamrong Cheam, Fouquieres-Les-Bethune (FR)

Correspondence Address: YOUNG & THOMPSON, 745 SOUTH 23RD STREET, 2ND FLOOR, ARLINGTON, VA, 22202, US

(21) Appl. No.: 10/520,415

(22) PCT Filed: Jul. 8, 2003
(86) PCT No.: PCT/FR03/02119

§ 371 Date: Oct. 4, 2005

(51) Int. Cl. D21H 23/00; D21H 19/00; C09J 105/00; B32B 29/00

(52) U.S. Cl. 162/135; 162/100; 442/299; 156/336

(57) ABSTRACT

A method for the finishing treatment of a fibrous web, includes applying on the fibrous web a polymer adhesive composition including a combination of optionally hydrogenated saccharides, having a low monosaccharide and disaccharide content, a limited polysaccharide content but a sufficiently high oligosaccharide content between DP 3 and DP 9. The invention also concerns a resulting paper or flat cardboard with enhanced physical, mechanical and/or optical properties.

The present invention relates to a novel process for finishing treatment of a fibrous web employing an adhesive composition based on polymer(s), which is presented and applied optionally diluted, in aqueous form or in a solvent medium, containing a specific combination of different saccharides, said combination comprising monosaccharide(s), disaccharide(s), oligosaccharides and/or polysaccharide(s), preferably hydrogenated.

It is also targeted at an adhesive composition based on polymers containing a specific combination of saccharides of use in such a finishing treatment of the fibrous web.

It is also targeted at the use of said composition for a treatment intended for the finishing of a fibrous web, in particular of paper, flat board or “nonwoven” material type, intended more particularly for the improvement of the physical, mechanical and/or optical characteristics of said paper, flat board or “nonwoven” material, or else for the assembling of different corresponding components, such as papers, flat boards and/or “nonwoven” materials.

It is also targeted at the fibrous web obtained after said finishing treatment and exhibiting improved physical, mechanical and/or optical properties.

Finally, it is targeted at the improvement in the characteristics of materials, such as papers, flat boards and/or “nonwoven” materials, which are assembled, such as, for example, multijet or laminated papers.

The term “finishing treatment process”, within the meaning of the invention, is understood to mean any process which makes possible the application of a uniform and perfectly even layer of material, homogeneously withdrawn from an adhesive composition, over a fibrous web.

Said fibrous web can result from any process which makes possible its formation in an aqueous medium. It is then commonly denoted under the terms of paper or flat board, in particular when the web is predominantly composed of cellulose fibers, or under the terms of nonwoven sheet, or alternatively of mat, in the converse case.

Said fibrous web can also be obtained by any process making possible the entangling of fibers without the help of water. The webs are then “nonwoven webs” within the broadest sense, produced in particular by virtue of mechanical or electromechanical means, for example.

The finishing treatments which are optionally applied to them involve aqueous or nonaqueous compositions, without there being a clearly established connection between the method of formation of the web and the nature, aqueous or nonaqueous, of said finishing treatment.

The term “adhesive composition based on polymer(s)”, within the meaning of the invention, is understood to mean any polymer, or any combination of polymers, capable of being soluble in water or soluble in a solvent other than water, or any polymer in dispersion or in emulsion, and also polymerizable prepolymerizates, and their various possible blends, provided that they meet the needs, in particular of compatibility, recognized or expressed by a person skilled in the art.

The term “water-soluble polymers” is understood to mean generally the various adhesive materials soluble in the specific solvent which water constitutes. These polymers are commonly used in industry. They are, in particular, very widespread in the paper manufacturing industry, in the context of finishing treatments, such as surface treatment, pigmented surface treatment or coating.

They are mostly organic macromolecular systems of natural origin, such as, for example, casein, gelatin, alginates, various plant proteins, certain cellulose derivatives, starch and its derivatives, or certain gums, such as, for example, guar gum, or of synthetic origin, such as polyvinyl alcohols.

All these adhesives or similar products have it in common that they can be easily applied, within a broad temperature range, but the removal of the solvent by evaporation, diffusion or seeping is generally lengthy, expensive and difficult to regulate, in this specific case of water as solvent.

The aqueous solutions of these adhesives suffer in addition from a sometimes poorly controlled Theological behavior difficult to reconcile with the needs of storage, of processing and of use. Specifically, they very often exhibit a more or less marked tendency to thicken over time and/or on standing or a more or less marked propensity for substantial variations in viscosity due to their sensitivity to shearing or by thixotropy.

Polymers which are soluble in a solvent medium for their part generally exhibit the disadvantages, formidable and generally dissuasive or crippling, of inflammability and toxicity.

The polymers provided in the dispersion, suspension or emulsion form are very often recognized under the generic term “latexes”, are synthetic and cover colloidal dispersions in water of polymers or copolymers in combination with various minor constituents, such as soaps, electrolytes and traces of catalysts.

The most well known amidst numerous families and alternative forms, and used in particular for the finishing of paper products, include, for example, styrene-butadiene latexes, which are widely distributed, acrylic emulsions, themselves also provided in highly diverse ways on bases of acrylic or methacrylic polymers or copolymers, butadiene-acrylonitrile copolymers or polyvinyl acetates.

The term “prepolymerizates”, within the meaning of the invention, is understood to mean all adhesives for which it may be considered that they are composed of systems capable of undergoing polymerization and/or crosslinking, which operation allows recourse to polymers exhibiting low molecular masses.

This class, which comprises, for example, formaldehyde resins of resorcinol-formaldehyde, urea-formaldehyde or phenol-formaldehyde type, certain natural or synthetic rubbers, epoxy resins, but also various preparations comprising polymerizable carboxylic acids, such as sorbic acid, crotonic acid and/or fumaric acid, for example, exhibits an obvious advantage of easy processing at low viscosities.

It is obvious that, in view of the needs of supplying, of cost, of storage, of processing, of use and of the requirements related to the performances desired, compared with the advantages and disadvantages of the various classes set out, a person skilled in the art will be led to choose, as is most convenient for him, one or other of these families or, optionally, a combination of components belonging to several of them.

Thus, it is not uncommon, in adhesive compositions, to find, for example, mixtures of formaldehyde resin(s) and of starch(es) or, for example, combinations of styrene-butadiene latex and of starch.

Very generally, amylaceous materials, modified or unmodified starches, are an important source of adhesive substances, for the most part soluble in water after they have been subjected to the heating or “cooking” stage, easy to supply and relatively inexpensive.

Adhesives based on amylaceous materials are very commonly used, in various forms, in adhesive compositions and constitute the entire, most of or a portion of the adhesive polymer component of said adhesive compositions of use in the treatment intended for the finishing of paper, very particularly during operations known to a person skilled in the art under the conventional names of surface treatment, pigmented surface treatment or coating.

In this field, which relates more specifically to paper manufacturing applications, reference may be made, for example, to the content of the work “Industrial Uses of Starches and its Derivatives”, edited by J. A. Radley, Applied Science Publishers Ltd, pages 207 to 224, “The Paper Industry” chapter, 1976 edition.

As is apparent in particular in this document, starch is the main agent for surface treatment or pigmented surface treatment, provided that it exhibits, in aqueous solution, a reduced viscosity. It is also, within a broader range of viscosities and molecular masses, an agent widely used in the preparation of coating formulations.

The 1967 edition of “Starch: Chemistry and Technology, Volume II, Industrial Aspects” (R. L. Whistler, Academic Press) sheds light on the practice thereof, in particular pages 130 to 143.

The compositions according to the invention, faithful to these fundamental options reported in the documents mentioned, will thus resort largely to oxidized starches, dextrins, starches resulting from acid hydrolysis, and/or etherified or esterified starches, and/or starches having undergone a thermochemical or enzymatic conversion which are continuous or batchwise.

In particular, thermochemical and enzymatic conversions, carried out next to the machines which use them, today occupy a place of choice in the paper manufacturing industry, in particular because of the possibilities which they offer in the levels of converting, and also because of their flexibility of operation, related to easy and rapid modifications to the parameters on appropriate and reliable equipment.

French patent FR 2 149 640, for example, filed on behalf of the applicant company, provides, in the field of the enzymatic conversion of starch, means developed for practicing with high solids contents, in particular by continuously supplying granular starch, optionally moistened, directly to the reaction chamber.

Furthermore, it should be understood that numerous improving agents, such as those which will make it possible to enhance, for example, the characteristics of water resistance of the adhesive deposited layer or to facilitate the crosslinking of the polymers present, or such as plasticizers, surface-active agents or agents for wetting surfaces, or barrier agents to oxygen or to fatty substances, may be involved in said adhesive compositions based on polymers, in particular based on amylaceous materials.

Said adhesive compositions can also comprise, for example, antifoaming agents, fluorescent whitening agents, agents for improving the slippage, lubricants, colorants or others.

French patent 2 149 640, mentioned above, touches on a number of them, the roles of which may be very different, such as:
plasticizing agents, such as, for example, sodium nitrate, urea, dicyandiamide, glycerol or sorbitol,
stabilizing agents, such as, for example, fatty adjuvants of the stearate type,
agents which increase the viscosity of starches, such as, for example, borax, sodium metaborate, sodium aluminate or aluminum sulfate,
agents which slow down swelling, such as, for example, sodium sulfate and sodium citrate,
agents which fluidify amylaceous powders, such as, for example, colloidal silica.

The use of sorbitol, thus mentioned in this French patent 2 149 640, is also touched upon in the documents below:
international patent application WO 99/39838, which claims, in a coating slip with the latex furthermore comprising silica, the use of sorbitol for the manufacture of a paper with antislip properties and of good printability,
patent U.S. Pat. No. 5,449,551, which claims a composition comprising sorbitol, glycerol and oil for impregnating fibers and obtaining a paper exhibiting excellent smoothness and good resistance to variations in ambient humidity.

International patent application WO 02/12388 claims, for its part, means which make it possible to reduce the viscosity of aqueous polysaccharide compositions essentially composed of carbohydrate gums, such as agar, guar gum, xanthan gums, gum arabic or certain cellulose ethers, in particular in the context of the participation of oxidized gums, by virtue of the incorporation of agents chosen from polyethylene glycols, but only for the purposes of reducing viscosity.

In addition to the fact that the field of the invention disclosed in this patent application preferentially covers oxidized gums, in particular cationic gums, no other object than that of the viscosity is mentioned. Thus it is that the following notions appear in an obviously secondary context: enzymatic activity, in examples 5 to 7, consequently, effectiveness toward oxidation, in examples 8 to 11, paper strengthening agents, in example 15, or dissolution of the oxidized gums, in the following examples.

Patent U.S. Pat. No. 4,155,884 provides an appropriate continuous embodiment of a composition consisting essentially of a starch solution. However, while said preparation can advantageously be brought into contact with an alcohol, preferably methanol, ethanol, n-propanol, x-hexanol, ethylene, propylene and hexylene glycols, or glycerol, it cannot be considered that this is an adhesive composition as targeted by the present invention insofar as, at the same time as the use of a polyhydric alcohol, a polybasic acid or anhydride is added for the purposes of manufacturing a polyester.

Likewise, international patent application WO 02/08517 claims a coating composition comprising a pigment and a starch having formed the subject of a modification allowing its crosslinking, which composition is preferably obtained by subjecting an aqueous dispersion of the starch to significant shear forces, preferably in an extruder, in the presence of water and of an alcohol, such as ethanol.

In addition, it is specified that the extrusion operation can be carried out with the help, in addition to water or the water/alcohol mixture, of a plasticizer, such as ethylene glycol, propylene glycol, polyglycols, glycerol, sucrose, maltose, maltodextrins, sugar alcohols, such as sorbitol, urea or sodium lactate.

This listing is fairly close to that given in French patent FR 2 149 640 and in fact constitutes only a variation of the assessment of the plasticization function, making use of it, optionally, it being possible for the water to suffice by itself, within a machine which applies particularly high shear forces to the composition.

Japanese patent JP 6136168 also relates to a process for the manufacture of amylaceous foams which consists, in addition to the fact of the existence of a phase of expansion, in particular in the presence of a volatile solvent, in subjecting an amylaceous substance to an operation of liquefaction by the action of the temperature in the presence of an acid catalyst, i.e. an inorganic acid, an organic acid or a Lewis acid, and of a polyol chosen from aliphatic polyalcohols, polyol polyesters or polyethers.

International patent application WO 92/03063 envisages the preparation of a suspension of starch granules, which are insoluble in cold water, the aqueous phase comprising a polyhydric alcohol chosen from the group formed by 1,2- and 1,3-propanediol, butanol isomers and glycerol. The heating of said preparation and the subsequent drying are used for the purposes of obtaining crystalline structures desired for starches soluble in cold water.

In addition to the polymers and additives, essential or subsidiary, of the adhesive compositions according to the invention mentioned above, the preparations for pigmented surface treatments and the preparations necessary for light coating can comprise, together with the more or less optional use of standard dispersants, such as sodium salts of phosphoric acid and silica, proteinates, surfactants, such as, for example, alkane- or alkylarenesulfonic derivatives, various fillers known to a person skilled in the art for their relatively common use, such as calcium carbonate, kaolin, talc, satin white, titanium oxide, natural, calcined or synthetic silicas, or various bentonites, or others less widely used, such as calcium sulfate, calcium sulfite, calcium silicate, barium sulfate, alumina hydrate, zeolites, zinc oxide or zinc sulfide, or even organic fillers, such as polystyrene or polymethyleneurea.

From a soundly based report, only the various synthetic polymers already mentioned are therefore capable of being used in combination, with the proviso of being compatible, with the starch for the improvement in the mechanical and/or physical and/or optical characteristics of the paper, whether in the dry or wet state, this being in comparison with the use of the starch alone as polymer.

In other words, there do not exist, to the knowledge of the applicant company, simple processing means, consisting in particular of additions to adhesive compositions in all proportions, which are relatively inexpensive, which respect the environment and which make it possible, in all circumstances and, furthermore, without risk of harmful symptoms or symptoms of incompatibility, to improve the physical, mechanical and/or optical characteristics of papers and other fibrous webs.

In point of fact, there exists an entirely real need, for papers capable of being subjected to a finishing, surface, pigmented surface or optionally coating treatment, preferably “light” coating treatment, to have access, by simple means devoid of any damage, to substantial possibilities of improving the mechanical and/or physical properties which, in fact, would make it possible:
to manufacture paper with superior qualities,
to reduce the grammage, with more or less identical properties,
to overcome the weaknesses sometimes brought about by defective provision or, more simply, resulting, for example, from excessively numerous or excessively great recyclings,
to reduce the costs of said provision, and/or
to reduce the costs of the post-treatments.

It is to the credit of the applicant company to have found, after numerous studies, that such means can reside in a finishing treatment, in particular a surface treatment, pigmented surface treatment or “light” coating treatment, providing for the additional or essential use, in adhesive compositions used for this purpose, depending on the requirements and needs for the manufacture of paper, of specific combinations of saccharides, comprising monosaccharides, disaccharides, oligosaccharides and/or polysaccharides.

The term “combinations of saccharides” is understood to mean, within the meaning of the present invention, in particular hydrolysates of starch and other polysaccharides, optionally partially or completely hydrogenated, exhibiting a defined glucide profile, which characterizes them and distinguishes them from one another with all the preciseness necessary, features and distinctions being capable of being related to more or less specific effects on the properties of the paper.

Among other possibilities, these combinations of saccharides can be created “from start to finish” by the appropriate blend of two or more saccharide compositions, said blend exhibiting the defined glucide profile.

A particular aim of the invention is to provide preparers of solutions/dispersions intended for the finishing of paper or paper manufacturers themselves, directly involved in the preparation, in the processing and/or in the use of these solutions/dispersions, as well as in the properties conferred on paper or flat board, with combinations of saccharides, in particular starch hydrolysates, which are optionally partially or completely hydrogenated, which can exhibit an array of properties of advantage in such applications.

The applicant company can in particular be credited with determining that the combinations of optionally partially or completely hydrogenated saccharides corresponding to the desired properties must not be either too rich in polysaccharides of high molecular weight or too rich in saccharides of low molecular weight, in particular in mono- or disaccharides.

This is because products rich in polysaccharides, apart from the fact that they can excessively increase the viscosity or could even result in problems of syneresis, constitute a contribution with an effect on the adhesive composition similar to that of a starch.

Conversely, a combination rich in saccharides of low molecular weight essentially fulfills a role similar to that of sorbitol, that is to say that mainly of plasticizing agent.

Consequently, the combinations of optionally partially or completely hydrogenated saccharides used in accordance with the invention are characterized by a relatively high content of oligosaccharides, simultaneously with a relatively low content of saccharides of low molecular weight and of polysaccharides.

More particularly, the abovementioned combinations of polysaccharides have a high content of oligosaccharides from DP (degree of polymerization) 3 to DP 9 and a relatively low amount of mono- and disaccharides and of polysaccharides with a DP at least equal to 10.

This content of polysaccharides with a DP of greater than 10 is in particular sufficiently low for it to be possible to distinguish, without any ambiguity, the saccharide combinations according to the invention from any amylaceous composition currently used in the paper manufacturing field, in particular in finishing operations, and obtained by any conventional means, such as acid hydrolysis or enzymatic or thermochemical conversions.

This is because said amylaceous compositions known to a person skilled in the art and currently used are manifestly different in their nature, since they exhibit average molecular masses generally of greater than 100 000 daltons. Furthermore, the hydrogenation of such weakly hydrolyzed compositions is of no great significance.

More specifically still, the combinations of saccharides used in accordance with the invention are characterized by a content of polysaccharides with a DP at least equal to 10 of at most equal to 70% by weight, with respect to the solids content of said combinations.

This content of polysaccharides is more advantageously between 25 and 70%, preferably between 25 and 65% (dry/dry).

Moreover, it has been more particularly observed that the combinations of saccharides exhibiting these contents of polysaccharides with a DP at least equal to 10 but observing, in addition, proportions relating to the fraction from DP 10 to DP 20 of at most equal to 30%, preferably of between 15 and 30%, were capable of improving, in an altogether substantial way, the physical, mechanical or optical properties and characteristics of the paper which are desired and mentioned above, this fact being accompanied by advantageous rheological data, in particular with regard to the stability, both for the combinations used in accordance with the invention and for the compositions in which they are involved.

It is also to the credit of the applicant company to have observed that such combinations of saccharides observing the conditions defined above were increasingly satisfactory in terms of physical and mechanical properties of the paper which were mentioned above as their content of oligosaccharides from DP 3 to DP 9 was greater than or equal to 30%, with respect to the dry total combination of saccharides.

It has thus been observed that it was very particularly advantageous, in order to draw the best advantage from the presence of these saccharides from DP 3 to DP 9 in the paper or flat board, for the paper or flat board to comprise, after the surface sizing treatment targeted at their possible finishing starting from the compositions according to the invention, which may or may not be pigmented, an amount of oligosaccharides from DP 3 to DP 9 of between 0.001 and 3 g/m², preferably between 0.01 and 2 g/m² and more preferably still between 0.1 and 1 g/m², or a proportion of said saccharides from DP 3 to DP 9, with respect to the weight of the paper, of between 0.0001 and 10%.

According to a particularly advantageous implementation of the invention, the combinations of saccharides used exhibit a content of oligosaccharides from DP 3 to DP 9 of between 30 and 70%, preferably between 35 and 60%, with respect to the dry total combination of saccharides.

The applicant company has thus been credited with finding that, for this specific application targeted at finishing treatments for paper, there is an essential advantage in using combinations of saccharides with a high, indeed even very high, content of DP 3 to DP 9. However, it has found that very particular importance was to be attached to the fraction corresponding to the oligosaccharides from DP 5 to DP 7, determining that it is entirely advantageous for this fraction to represent at least 10% of all the dry combination of saccharides. More preferably, this content of oligosaccharides from DP 5 to DP 7 is between 10 and 35%.

By way of example, combinations of saccharides, or starch hydrolysates, which are particularly satisfactory in the exercise of the invention can be obtained by an acidic or enzymatic liquefaction of a starch, resulting in a DE (Dextrose Equivalent) of approximately 30, followed by the exclusion, by molecular sieving, of a significant fraction of the products with high DP values and/or of another significant fraction of the products with DP values of less than 3.

To carry out the hydrolyses and molecular sievings under consideration, modified or unmodified starches of any origin, such as potato, amylopectin-rich potato, manioc, maize, waxy maize, wheat, rice or pea starches, can be used.

To obtain the corresponding completely or partially hydrogenated products, said sieved hydrolysis product is subjected, in all or in part, to a conventional hydrogenation, in particular by the method with Raney nickel.

It is important to consider that the combinations of saccharides which are particularly satisfactory within the meaning of the invention, due to their low content of saccharides of low molecular weight, will not be subjected to harmful aspects in terms of physical and mechanical properties of the paper while contributing properties of stability to the adhesive compositions and plasticizing properties to the treated paper.

A high content of saccharides of low molecular weight has been found to be harmful in this respect, while, in contrast, being beneficial to the stability of the compositions and to the plasticizing effect. The aptitude, in terms of plasticizing properties, exhibited by such combinations rich in saccharides of low molecular weight is known but cannot constitute, as such and by itself alone, the subject matter of the invention, while being capable of being part of it.

In accordance with all these observations, the combinations of saccharides which can be used in accordance with the invention exhibit a content of monosaccharides and disaccharides, i.e. of products with degrees of polymerization of 1 and 2, of less than or equal to 30%.

This overall content of monosaccharides and of disaccharides is at most equal to 28%, preferably between 0.5 and 28%.

These percentages are with respect to the dry total combination of saccharides.

Thus, generally, the combinations of saccharides in accordance with the invention which best meet the objectives set exhibit a glucide spectrum defined by contents:
of monosaccharides and disaccharides of less than or equal to 30%, preferably of less than 28%, more preferably still of between 0.5 and 28%,
of oligosaccharides from DP 3 to DP 9 of greater than or equal to 30%, preferably of between 30 and 70%, more preferably of between 35 and 60%,
of polysaccharides with a DP at least equal to 10 of less than 70%, preferably of between 25 and 70% and more preferably still of between 25 and 65%,
   said contents being expressed as weight by weight with respect to the solids content of said combinations.

The combinations of optionally hydrogenated saccharides used in accordance with the invention can be presented in the form of syrups which are sufficiently concentrated to prevent any bacterial growth and exhibit an appropriate and stable viscosity to respond comfortably to any restriction of feeding, of storage or of circulation.

In this form, and after optional dilution at the time of use, they will be introduced without difficulty into compositions formed of water-soluble or water-dispersible polymers by any means at the convenience of the user, provided that the conditions of homogeneity of the finished composition are respected.

In the specific case of an enzymatic conversion, said combinations can also, optionally, be added in intermediate stages which facilitate or simplify the various handling operations, in the supplementary enzyme, optionally diluted, or be introduced at whatever stage of the enzymatic conversion, whether continuous or batchwise.

The combinations of saccharides which can be used in accordance with the invention can also be presented in the form of powders, the latter exhibiting flow characteristics such that they can be introduced without distinction into the composition formed of soluble polymers or be dispersible in one of these polymers only, whether in the solution, dispersion or even powder form.

In the specific case of the enzymatic conversion of starches, the user will experience no difficulty in introducing such powders at whatever stage of a continuous or batchwise conversion.

Under the conditions mentioned, and without them being able to assume any limiting nature, the combinations of saccharides used in accordance with the invention are capable of being introduced in all proportions into the adhesive compositions according to the invention.

This is because an extreme proposal can consist of a finishing treatment for the paper composed virtually exclusively of a combination of saccharides according to the invention. This possibility may be made use of, for example, in the context of application conditions for which the importance of the viscosity is entirely insignificant and/or the visual factor is itself of secondary importance, as in the case of a supplementary treatment of recycled fibers.

Conversely, the combinations of saccharides according to the invention are capable of participating in any finishing treatment, in particular relatively unsophisticated treatments, such as surface treatment with starch, surface treatment with starch enriched with any resin, dispersion or solution, capable of conferring one or more specific properties, such as resistance to water or to fats or “barrier” ability to oxygen. The amount of combination with respect to the composition will then be smaller.

The combinations of saccharides used according to the invention are capable of also participating in more sophisticated treatments where, obviously, their contribution will appear to be substantially smaller, such as, for example, in the context of a pigmented surface treatment or even of a coating, according to circumstances.

However, whatever the treatment conditions chosen or imposed, and taking into account the fact that there does not really exist limits other than the inconvenient possibility of a supplementary introduction and the cost, to be compared with the gain(s) obtained, numerous benefits can be drawn from the introduction of the combinations of saccharides into adhesive compositions for the treatment of paper, it being possible for said benefits themselves to assume multiple forms, such as:

to effectively present a paper with superior qualities,
to reduce the grammage, with more or less identical properties,
to overcome the weaknesses sometimes brought about by defective provision or, more simply, resulting, for example, from excessively numerous or excessively great recyclings,
to reduce the costs of said provision, and/or
to reduce the costs of the posttreatments.

To achieve such diverse objectives, both in their nature and in their degree of importance, the amount of combination of optionally partially or completely hydrogenated saccharides which is introduced into the adhesive composition can be extremely variable and can in fact be between 0.01 and 100% (dry/dry).

However, it is considered that a combination of saccharides comprising 30 to 70% of oligosaccharides with a DP of between 3 and 9 is very advantageously used in proportions varying between 0.1 and 20%, these various percentages being expressed as dry/dry of the adhesive composition.

In other words, the adhesive composition itself exhibits, entirely advantageously, a content of oligosaccharides from DP 3 to DP 9 of between 0.03% and 14% (dry/dry).

Apart from the possibility of a treatment carried out using essentially the combination of saccharides alone, a possibility in which, obviously, said amount will be close to 100%, the level of introduction is generally more particularly between 0.1 and 20% and preferably between 0.2 and 5%, these percentages being calculated as solids content and related to the dry total composition.

The present invention will be described in more detail using the examples which follow, which are in no way limiting.

### EXAMPLE 1

The enzymatic conversion of a native wheat starch is carried out continuously by preparing a milk with a solids content of 39%, to which an enzyme, BAN 240, sold by Novo, is added in a proportion of 0.05% with respect to the commercial starch.

The device for continuous enzymatic conversion is regulated so that the temperature to which the product to be converted is subjected is maintained at 85° C. for 10 minutes and so that it is possible subsequently to fully deactivate the enzyme by maintaining the adhesive at 130° C. for 1 minute 30 seconds.

The adhesive is subsequently adjusted to a solids content of 20%.

Withdrawn samples of said adhesive have added to them, in comparison with controls, 8%, calculated with respect to the amylaceous material:
of sorbitol, in the form of a syrup with a solids content of 70%,

or of a combination of saccharides, referred to as C 1, in accordance with the invention, consisting of a hydrogenated starch hydrolysate, provided at a solids content of 70% and corresponding to the following analysis, with respect to the solids content:

| | |
|---|---|
| DP 1 and 2 | 24.6 |
| DP 3 to DP 9 | 53.5 |
| DP 5 to DP 7 | 23.4 |
| DP ≧ 10 | 21.2 |
| DP 10 to DP 20 | 16.7 |

The change in the viscosity of these preparations on cooling is observed on a Brookfield viscometer at 100 rpm, in comparison with a first adhesive (control 1) withdrawn before addition of sorbitol or of hydrogenated hydrolysate and with a second adhesive (control 2) prepared separately.

TABLE I
Brookfield viscosity in mPa · s:

| | | | 8% of | |
|---|---|---|---|---|
| Temperature | | 8% of | combination | |
| (° C.) | Control 1 | sorbitol | C 1 | Control 2 |
| 70° C. | 95 | 88 | 82 | 126 |
| 60° C. | 120 | 100 | 98 | 137 |
| 50° C. | 138 | 128 | 116 | 160 |
| 40° C. | 180 | 148 | 126 | 198 |
| 30° C. | 228 | 185 | 140 | 240 |
| 20° C. | 292 | 220 | 172 | 305 |
| pH | 8.2 | 7.1 | 7 | 7.1 |

It is found that, far from harming the stability of the adhesive, the saccharide combinations selected according to the invention reinforce the stability of the adhesive on cooling.

In particular, the hydrogenated starch hydrolysate rich in oligosaccharides (combination C 1) has an effect, from this viewpoint, which is particularly advantageous.

### EXAMPLE 2

In the context of a new enzymatic conversion, the essential operating conditions differ from those of example 1 only in that a premix of enzyme and of hydrogenated starch hydrolysate is prepared.

The reuse of the operating conditions of example 1 thus results in the preparation of a mixture between BAN 240 enzyme and hydrogenated starch hydrolysate capable of being employed directly for the conversion and comprising 0.62% of the enzyme.

Each of the preparations concerned is stored under standardized conditions, i.e. at 25° C., and for periods regarded as significant, which are arbitrarily set at four days or at two months respectively. At the end of these periods, the activity of the enzyme is monitored. The following are thus recorded, it being known that the enzymatic activity of pure BAN 240 is 204 KNU/g:

TABLE II

| | BAN 240/sorbitol | | BAN 240/C 1 | |
|---|---|---|---|---|
| Storage | 4 days | 2 months | 4 days | 2 months |
| Enzymatic | 1.29 | 1.28 | 1.21 | 1.27 |
| activity | | | | |
| (KNU/g) | | | | |
| pH | 6.3 | 6 | 6.3 | 6 |

On taking into account the starting enzymatic activity and the dilution, it may be maintained that, overall, the presence of hydrogenated starch hydrolysate does not in any way harm the enzymatic activity, this being the case even after a lengthy storage period.

Mixtures of enzyme with sorbitol or the combination C 1 can be prepared, without any damage and for greater ease, long before they are used.

### EXAMPLE 3

A new enzymatic conversion of a native wheat starch is carried out continuously under the conditions described in example 1, except that this time the Enzysize L 125 enzyme, sold by Genencor, is used, in amounts such that, after conversion and specific dilution conditions, an adhesive is obtained which, at a solids content of 17% and at 60° C., exhibits a viscosity, measured on a Brookfield viscometer, as desired, i.e. close to 250 mPa·s.

This adhesive, thus converted, is intended to be applied, by a surface treatment operation on a size press, to a corrugating paper, the grammage of which is in the region of 120 g/m², under conditions of controlled distribution such that the deposition, as starch, is in the region of 3 g/m² for each of the faces.

The objective is to act favorably on the properties of said corrugating paper (bursting strength) or those of the corrugated board prepared with the adhesive (CMT 30).

However, before carrying out said surface treatment operation, the addition is carried out, to the adhesive, of a synthetic adhesive agent in amounts such that it occurs in a proportion of 0.5% (commercial material/dry) with respect to the paper and optionally, by way of comparison:
2% of sorbitol or
2% of combination C 1, these percentages being calculated with respect to the paper.

After the surface treatment operation has been carried out on a pilot-scale size press from Dixon under the required conditions, that is to say conditions corresponding to adhesives presented at 50° C. or 70° C., burst factor and CMT 30 measurements are carried out in a climate-controlled atmosphere (23° C., 50% relative humidity or RH), in comparison with the untreated support.

The results are presented in Table III below.

TABLE III
Measurements after surface treatment with
adhesives presented at 50° C. and 70° C.

| | | Bursting | |
|---|---|---|---|
| | | strength (N) | CMT 30 |
| Paper | | 175 | 11 |
| Treated | adhesive | 287 | 18 |
| paper | 2% sorbitol | 295 | 18.5 |
| [adhesives | 2% C 1 | 297 | 19 |
| at 50° C.] | | | |
| Treated | adhesive | 290 | 17.5 |
| paper | 2% sorbitol | 302 | 19 |
| [adhesives | 2% C 1 | 300 | 19.5 |
| at 70° C.] | adhesive | 293 | 17.7 |

The gains obtained with the contribution of the converted adhesives are obvious, whether or not they receive saccharides.

A substantial improvement is observed with regard to the CMT 30 (Concora Medium Tester) index, the tendency being more marked with the combination C 1.

The same tendencies may be observed when the tests are carried out starting from adhesives heated at 70° C.

Likewise, and more markedly still, they appear when the paper has been preheated at 70° C.

Furthermore, it is noted that the wettability, measured by the PDA (Penetration Dynamic Analysis), a relative quantity corresponding to the time necessary for water to come into contact with the paper, is substantially improved. This is because the time necessary for the wetting is significantly reduced by the contribution of sorbitol and in particular of the combination C 1, i.e. in a comparative fashion between treatments by an adhesive to which sorbital or combination of saccharides has been added, with respect to an adhesive not comprising adjuvants.

### EXAMPLE 4

Another enzymatic conversion is carried out continuously, this time performed on potato starch.

For this, a potato starch milk is prepared comprising 30% of commercial material.

0.125% of Lysase 2000 enzyme, sold by Genencor, is added thereto, this addition being calculated with respect to the commercial amylaceous material.

The reaction time in the continuous reactor is regulated to approximately 20 minutes, so that an adhesive with a solids content of 22.5% is obtained, the pH of which read is approximately 6 and the viscosity of which is approximately 200 mPa·s, measured with a Brookfield viscometer at 65° C.

It is stored as is.

After appropriate dilution, a surface treatment operation is carried out, performed by virtue of a pilot scale device from Dixon on a paper intended for printing or writing with a grammage in the region of 65 g/m², so that the deposited layer of amylaceous material is more or less in the region of 3 g/m², thus corresponding to approximately 5% of amylaceous material, calculated with respect to the weight of the fibrous mat.

A control is composed of a paper treated with the adhesive as described above.

A second surface treatment operation is carried out with the same adhesive which has additionally received approximately 7.5% of the combination C 1, calculated with respect to the amylaceous material. Thus, the contribution of the combination C 1 to the paper represents approximately 0.375% of the weight of the latter.

A relatively complete assessment has been compiled with regard to the various properties conferred on the paper, this in an essentially comparative fashion, the test being carried out in a climate-controlled atmosphere (23° C., 50% RH).

The measurements carried out are combined below:

| | Control - 5% | Test - 5% converted |
|---|---|---|
| | converted | potato starch + 0.7% |
| | potato | combination C 1/ |
| Reference | starch/paper | paper |
| Grammage | 60 | 60 |
| Thickness | 57 | 57 |
| Stiffness | | |
| machine direction | 0.16 | 0.183 (+14%) |
| cross machine direction | 0.07 | 0.08 (+14%) |
| Bendtsen smoothness | 250 | 295 (+18%) |
| Scott Bond | 400 | 565 (+41.2%) |
| Double fold | | |
| machine direction (MD) | 650 | 790 (+21.5%) |
| cross machine direction | 1100 | 1450 (+31.8%) |
| (CMD) | | |
| Burst factor | 3.5 | 3.73 (+6.5%) |
| Breaking length in | | |
| the dry state | | |
| machine direction | 7900 | 8000 |
| cross machine direction | 5750 | 6000 |
| CMD/MD | 0.72 | 0.75 |

It is thus found that certain quantities are only very slightly influenced by the addition of the combination of saccharides C 1, such as the thickness and the bulk, or the breaking length, whether in the dry or wet state.

This is also the case for the values relating to the optical properties, which are not listed, such as the whiteness or the opacity, or for the printability, in particular when examined using the IGT tests.

Certain physical or mechanical characteristics are very substantially improved, such as the stiffness, the smoothness, the double fold strength and, still more, the internal cohesion, reflected in the Scott Bond values.

### EXAMPLE 5

This operation is performed in a different way from those set out in examples 1 to 4, i.e. by “thermochemical” conversion and no longer enzymatic conversion.

In the present case, the thermochemical procedure corresponds essentially to the action of ammonium persulfate on a wheat starch milk prepared with a solids content of 24%.

The amount of commercial ammonium persulfate introduced is 2.5 parts per 1000 of dry wheat starch.

The adhesive obtained is stored at a solids content of 15.5% and at 75° C.

A control paper, exhibiting a grammage in the region of 120 g/m² and intended for the fluting of a corrugated board, receives an amount of dry wheat starch of approximately 6 g/m², calculated with respect to the paper, by surface treatment in a size press.

In a second step, comparative tests are carried out by using, in a size press, an adhesive as defined above but which has additionally received an amount of combination C 1 corresponding to 7%, calculated with respect to the dry wheat starch.

After a suitable period of conditioning in a climate-controlled chamber at 23° C. and 50% relative humidity (RH), measurements are carried out leading to the results listed below:

| | | Test with |
|---|---|---|
| Reference | Control - adhesive alone | combination C 1 |
| Grammage | 121 | 120 |
| Scott Bond | 297 | 295 |
| Stiffness | | |
| machine direction | 3.25 | 4.55 |
| cross machine | 1.5 | 1.5 |
| direction | | |

While it is observed that the internal cohesion is not apparently sensitive to the presence of the combination C 1, the gain in stiffness in the machine direction is quite spectacular, since it is equal to 40%.

1. A method for the finishing treatment of a fibrous web, wherein an adhesive composition formed of polymer(s) comprising a combination of optionally partially or completely hydrogenated saccharides is applied to said web, said combination of saccharidees having a glucide spectrum exhibiting:
a content of monosaccharides and disaccharides of less than or equal to 30%,
a content of oligosaccharides with degrees of polymerization (DP) of between 3 and 9 of greater than or equal to 30%,
a content of polysaccharides with a DP at least equal to 10 of less than or equal to 70%,
these percentages being expressed as dry weight with respect to the dry weight of the whole of the combination of saccharides.

2. The method according to claim 1, wherein the combination of saccharides has a content of monosaccharides and disaccharides (DP equal to 1 or 2) at most equal to 28%.

3. The method according to claim 1, wherein the combination of saccharides has a content of oligosaccharides with a DP of between 3 and 9 of between 30 and 70%.

4. The method according to claim 1, wherein the combination of saccharides has a content of polysaccharides of DP≧10 of between 25 and 70%.

5. The method according to claim 1, wherein the finishing treatment is carried out in an aqueous medium.

6. The method according to claim 1, wherein the fibers constituting the fibrous web are predominantly cellulose fibers.

7. The method according to claim 1, wherein the polymer or polymers of the adhesive composition is or are soluble or easily dispersible in water.

8. The method according to claim 1, wherein the combination of saccharides is present in the adhesive composition in an amount of between 0.01 and 100%, this amount being expressed as solids content with respect to the dry total adhesive composition.

9. The method according to claim 1, wherein the adhesive composition applied has a solids content (SC) of between 0.5 and 75%.

10. The method according to claim 1, wherein the finishing treatment consists of a surface treatment, pigmented surface treatment or coating operation.

11. An adhesive composition of use in the finishing treatment of a fibrous web, comprising a combination of optionally partially or completely hydrogenated saccharides exhibiting:
a content of monosaccharides and disaccharides (DP of 1 or 2) of less than or equal to 30%,
a content of oligosaccharides with a DP of between 3 and 9 of greater than or equal to 30%,
a content of polysaccharides with a DP at least equal to 10 of less than 70%,
these percentages being expressed as dry weight with respect to the dry weight of the whole of said combination of saccharides.

12. The adhesive composition according to claim 11, having a content of oligosaccharides from DP 3 to DP 9 of between 0.03% and 14%, these percentages being expressed as dry weight with respect to the dry weight of said composition.

13. An improved fibrous web, having a first and a second and on one and/or other of said faces, a deposited layer of an adhesive composition according to claim 11, which may or may not be pigmented, said deposited layer being produced in an amount, expressed as solids content, of between 0.05 and 15 grams/m² of paper or flat board.

14. The improved fibrous web according to claim 13, comprising an amount of oligosaccharides from DP 3 to DP 9 of between 0.001 and 20 g/m².

15. The method according to claim 1, wherein the combination of saccharides has a content of monosaccharides and disaccharides (DP equal to 1 or 2) of between 0.5 and 28%.

16. The method according to claim 1, wherein the combination of saccharides has a content of oligosaccharides with a DP of between 3 and 9 of between 35 and 60%.

17. The method according to claim 1, wherein the combination of saccharides has a content of polysaccharides of DP≧10 of between 25 and 65%.

18. The method according to claim 1, wherein the combination of saccharides is present in the adhesive composition in an amount of between 0.1 and 20%, this amount being expressed as solids content with respect to the dry total adhesive composition.

19. The method according to claim 1, wherein the combination of saccharides is present in the adhesive composition in the amount of between 0.2 and 10%, this amount being expressed as solids content with respect to the dry total adhesive composition.

20. The method according to claim 1, wherein the adhesive composition applied exhibits a solids content (SC) of between 1 and 50%.

21. The method according to claim 1, wherein the adhesive composition applied exhibits a solids content (SC) of between 2 and 20%.

22. The improved fibrous web according to claim 13, wherein said deposited layer is produced in an amount, expressed as solids content, of between 0.2 and 10 grams/m² of paper or flat board.

23. The improved fibrous web according to claim 13, comprising an amount of oligosaccharides from DP 3 to DP 9 of between 0.01 and 5 g/m².

24. The improved fibrous web according to claim 13, comprising an amount of oligosaccharides from DP 3 to DP 9 of between 0.1 and 1 g/m².

25. The improved fibrous web according to claim 13 comprising a proportion of oligosaccharides from DP 3 to DP 9 of between 0.0001 and 10%, with respect to the weight of the paper.
